(19) United States
(12) Patent Application Publication
(10) Pub. No.: US 2021/0041736 A1
(43) Pub. Date: Feb. 11, 2021

(54) LIQUID CRYSTAL DISPLAY

(71) Applicant: Mitsubishi Electric Corporation, Tokyo (JP)

(72) Inventors: Yukihiro KUDO, Tokyo (JP); Hiroshi UMEDA, Tokyo (JP)

(73) Assignee: Mitsubishi Electric Corporation, Tokyo (JP)

(21) Appl. No.: 16/944,541

(22) Filed: Jul. 31, 2020

(30) Foreign Application Priority Data
Aug. 8, 2019 (JP) 2019-146339

(51) Int. Cl. G02F 1/1339; G02F 1/1362; G02F 1/1337

(52) U.S. Cl. CPC G02F 1/13394; G02F 1/136286; G02F 2001/133357; G02F 2001/13396; G02F 1/1337

(57) ABSTRACT

An array substrate and an opposing substrate of a liquid crystal display are disposed to oppose each other to sandwich a liquid crystal. An alignment film is disposed over the first main surface of the array substrate to align the liquid crystal. A spacer is disposed between the array substrate and the opposing substrate. The spacer includes a base and a spacer body. The base is disposed over the first main surface of the array substrate. The spacer body is disposed over the second main surface of the opposing substrate. A top portion of the spacer body is in contact with the base. A height of the spacer body is compressed by being subjected to stress in a direction to move the array substrate and the opposing substrate towards each other. The base has a height greater than an amount of compression of the height of the spacer body.

### BACKGROUND OF THE INVENTION

### Field of the Invention

The present invention relates to liquid crystal displays.

### Description of the Background Art

A liquid crystal display includes a liquid crystal display panel in which a space between an array substrate and an opposing substrate is filled with a liquid crystal and is maintained by a spacer (see, for example, Japanese Patent Application Laid-Open No. 2002-341354, Japanese Patent Application Laid-Open No. 2005-189662, and Japanese Patent Application Laid-Open No. 2013-238729).

A liquid crystal display having a flat display surface has been the mainstream, but, from a design and space-saving standpoint, there is an increasing need for a liquid crystal display having a curved display surface, which is a so-called curved liquid crystal display. In a case where a liquid crystal display panel of the curved liquid crystal display is mass-produced using a glass substrate having a typical thickness, a manufacturing process of slimming the glass substrate, and then curving the liquid crystal display panel is taken.

The slimmed liquid crystal display panel is likely to be bent during handling, conveyance, and the like. Once the liquid crystal display panel is bent, relative displacement in in-plane directions of both the substrates occurs. As a result, a spacer is moved into an opening of a pixel to damage an alignment film.

In Japanese Patent Application Laid-Open No. 2002-341354, for example, a columnar spacer disposed on a color filter substrate and a stepped portion on an array substrate are disposed to oppose each other. Both the substrates are usually fixed in a state of being subjected to stress in a direction to move the substrates towards each other through the columnar spacer to hold a liquid crystal. In other words, the spacer is present between both the substrates in a compressed state. As a result of curving of both the substrates, the columnar spacer in the compressed state is removed from the stepped portion to be freed, and increases in length. If the columnar spacer is moved into a display region of a pixel in this state, the alignment film in the display region is damaged.

### SUMMARY

The present disclosure has been conceived to solve the above-mentioned problem, and it is an object to provide a liquid crystal display to prevent damage of an alignment film caused by displacement of a spacer occurring due to bending of substrates.

A liquid crystal display according to the disclosure includes an array substrate, an opposing substrate, and a spacer. The array substrate and the opposing substrate are disposed to oppose each other to sandwich a liquid crystal. The spacer is disposed between the first main surface of the array substrate and the second main surface of the opposing substrate to maintain a predetermined cell gap between the array substrate and the opposing substrate. The array substrate includes an alignment film. The alignment film is disposed over the first main surface to align the liquid crystal in a predetermined alignment processing direction. The spacer includes a base and a spacer body. The base is disposed over the first main surface of the array substrate. The spacer body is disposed over the second main surface of the opposing substrate. A top portion of the spacer body is in contact with the base. A height of the spacer body is compressed by being subjected to stress in a direction to move the array substrate and the opposing substrate towards each other. The base has a height greater than an amount of compression of the height of the spacer body.

According to the present disclosure, the liquid crystal display to prevent damage of the alignment film caused by displacement of the spacer occurring due to bending of the substrates is provided.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a sectional view illustrating a configuration of a liquid crystal display panel of a liquid crystal display in Embodiment 1;

FIG. 2 is a plan view illustrating a configuration of a pixel of the liquid crystal display in Embodiment 1;

FIG. 3 is a plan view illustrating one example of a moving range of a spacer body;

FIG. 4 is a sectional view illustrating a configuration of a liquid crystal display panel not including a spacer;

FIG. 5 is a sectional view illustrating a configuration of a liquid crystal display panel of a liquid crystal display in Embodiment 2;

FIG. 6 is a sectional view illustrating a configuration of a liquid crystal display panel of a liquid crystal display in Embodiment 3;

FIG. 7 is a sectional view illustrating a configuration of a liquid crystal display panel of a liquid crystal display in Embodiment 4;

FIG. 8 is a plan view illustrating a configuration of a pixel of a liquid crystal display in Embodiment 5; and

FIG. 9 is a perspective view illustrating a configuration of a liquid crystal display in Embodiment 7.

### DESCRIPTION OF THE PREFERRED EMBODIMENTS

### Embodiment 1

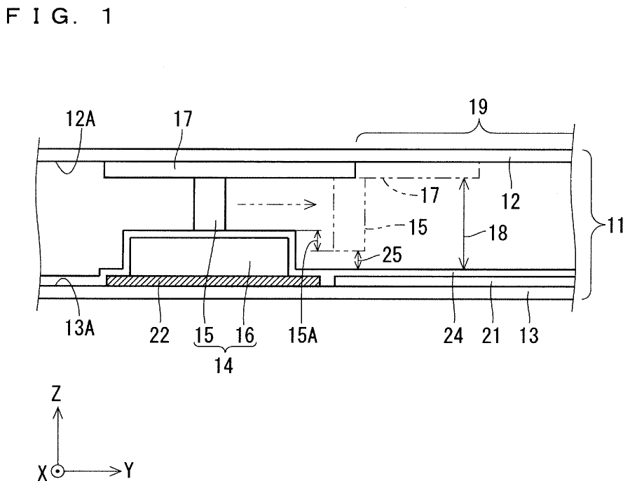

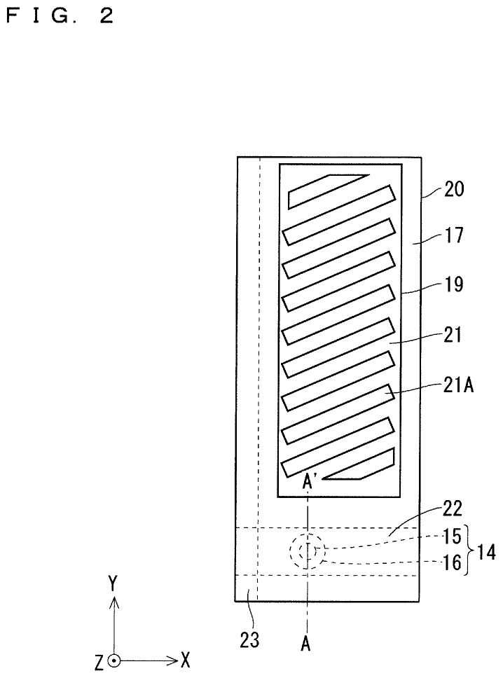

FIG. 1 is a sectional view illustrating a configuration of a liquid crystal display panel 11 of a liquid crystal display in Embodiment 1, and illustrates a cross section of a portion of a pixel 20, which will be described below. FIG. 2 is a plan view illustrating a configuration of the pixel 20 of the liquid crystal display in Embodiment 1. FIG. 1 corresponds to a cross section taken along the line A-A′ of FIG. 2. In Embodiment 1, description is made by taking a transverse electric field panel, such as an in-plane switching (IPS) panel and a fringe field switching (FFS) panel, as an example of the liquid crystal display panel 11.

The liquid crystal display panel 11 of the liquid crystal display includes an electrode substrate 13, an opposing substrate 12, and a spacer 14. The opposing substrate 12 and the electrode substrate 13 are disposed such that surfaces 12A and 13A thereof oppose each other. A space between the surface 12A of the opposing substrate 12 and the surface 13A of the electrode substrate 13 is filled with a liquid crystal (not illustrated).

A plurality of gate wires and a plurality of source wires are disposed over the surface 13A of the electrode substrate 13. In FIG. 2, only one gate wire 22 and one source wire 23 of these wires are illustrated. The plurality of gate wires extend in an X direction, and are arranged at predetermined intervals. The plurality of source wires extend in a Y direction, and are arranged at predetermined intervals. The plurality of gate wires and the plurality of source wires form a plurality of pixels arranged in a matrix to correspond to intersections of the plurality of gate wires and the plurality of source wires. In FIG. 2, one pixel 20 disposed to correspond to the one gate wire 22 and the one source wire 23 is illustrated. The pixel 20 includes a transistor (not illustrated), and the electrode substrate 13 is also referred to as a thin film transistor (TFT) array substrate or simply referred to as an array substrate.

A pixel electrode 21 and an alignment film 24 are disposed over the surface 13A of the electrode substrate 13.

The pixel electrode 21 is disposed to correspond to an opening 19 of the pixel 20. The opening 19 is a light transmissive region in the pixel 20, and is a region surrounded by a black matrix 17, which will be described below, in plan view. The pixel electrode 21 has slits 21A to control alignment of the liquid crystal. In Embodiment 1, the slits 21A are formed not parallel but obliquely to each of the gate wire 22 and the source wire 23.

The alignment film 24 is disposed on the pixel electrode 21. The alignment film 24 aligns the liquid crystal in a predetermined alignment processing direction. The alignment processing direction is determined, for example, by rubbing processing, light alignment processing, and the like. In Embodiment 1, the predetermined alignment processing direction corresponds to the X direction, that is, a direction of extension of the gate wire 22. The liquid crystal is aligned in the direction of extension of the gate wire 22 with no voltage being applied to the pixel electrode 21. In Embodiment 1, the alignment processing direction of the alignment film 24 and a direction of the slits 21A of the pixel electrode 21 form an acute angle of less than 4°.

The black matrix 17 to form the opening 19 of the pixel 20 is disposed over the surface 12A of the opposing substrate 12. The black matrix 17 covers the gate wire 22 and the source wire 23 in plan view to block light. A color filter may be disposed over the surface 12A of the opposing substrate 12 to correspond to the opening 19. The opposing substrate 12 is also referred to as a color filter substrate.

The spacer 14 is disposed between the surface 13A of the electrode substrate 13 and the surface 12A of the opposing substrate 12. The spacer 14 has a function to maintain a predetermined cell gap 18 between the electrode substrate 13 and the opposing substrate 12. The cell gap 18 corresponds to a distance from a bottom surface of a spacer body 15, which will be described below, and a surface of the alignment film 24. In Embodiment 1, the spacer 14 is disposed outside the opening 19 of at least one pixel 20.

More particularly, the spacer 14 is disposed on a side of the gate wire 22 connected to the transistor disposed in the pixel 20 relative to the opening 19. In other words, the spacer 14 is located, within one pixel 20, in a −Y direction of the opening 19. The spacer 14 is disposed at multiple locations of the liquid crystal display panel 11.

The spacer 14 includes a base 16 disposed over the surface 13A of the electrode substrate 13 and the spacer body 15 disposed over the surface 12A of the opposing substrate 12.

The spacer body 15 has a columnar shape. The shape of the spacer body 15, however, is not limited to the columnar shape. The top portion of the spacer body 15 is in contact with the base 16. The electrode substrate 13 and the opposing substrate 12 are fixed with stress being applied in a direction to move them towards each other when being joined through the spacer 14 in a process of manufacturing the liquid crystal display panel 11. In this case, the spacer body 15 is subjected to stress by the base 16 over the electrode substrate 13 to be pressed. That is to say, the spacer body 15 is compressed. The spacer body 15 thus has a smaller height after the electrode substrate 13 and the opposing substrate 12 are joined than before they are joined.

The base 16 has a height greater than an amount of pressing corresponding to the change in height of the spacer body 15 before and after joining, that is, an amount of compression 15A. The amount of compression 15A is preferably approximately 0.2 μm to 0.3 μm.

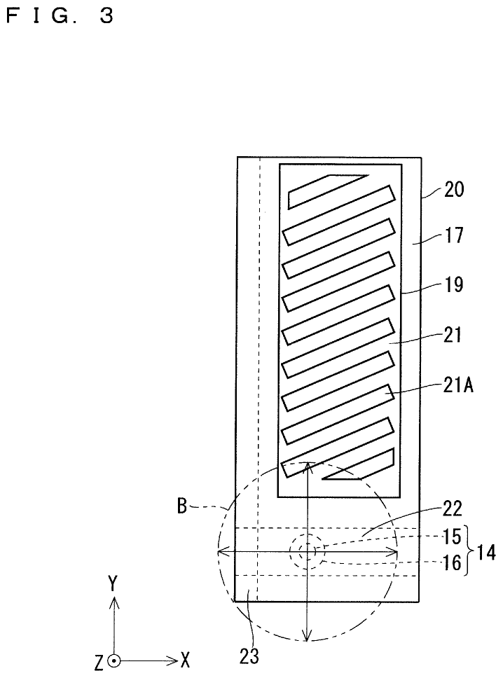

In a case where the liquid crystal display panel 11 is slimmed in a process of manufacturing the liquid crystal display in Embodiment 1, the liquid crystal display panel 11 is likely to be bent during handling, conveyance, and the like. Once the liquid crystal display panel 11 is bent, relative displacement in in-plane directions of the opposing substrate 12 and the electrode substrate 13 occurs. FIG. 3 is a plan view illustrating one example of a moving range B of the spacer body 15 in a case where such relative displacement occurs. An amount of movement of the spacer body 15 is dependent on an amount of bending of the liquid crystal display panel 11. A direction of movement of the spacer body 15 is dependent on a direction of bending of the liquid crystal display panel 11. The spacer body 15 is thus moved radially depending on how the liquid crystal display panel 11 is bent as illustrated in FIG. 3.

A case where the slimmed liquid crystal display panel 11 is bent in the Y direction in the process of manufacturing the liquid crystal display is described herein. As illustrated in FIG. 1, the black matrix 17 and the spacer body 15 over the opposing substrate 12 are moved in the +Y direction to locations shown by broken lines. In this case, the spacer body 15 is removed from the base 16 over the electrode substrate 13. The spacer body 15 removed from the base 16 is freed from stress of compression, and increases in length in accordance with the amount of compression 15A. The spacer body 15 is moved to the opening 19 of the pixel 20 in the state.

As described above, the base 16 has a height greater than the amount of compression 15A of the spacer body 15. The spacer body 15 in an uncompressed state thus has a height smaller than the cell gap 18. Even if the spacer body 15 is moved into the opening 19 of the pixel 20, there is a gap 25 between the top portion of the spacer body 15 and the alignment film 24 disposed on the pixel electrode 21 in the opening 19. The spacer body 15 thus does not contact and damage the alignment film 24. In a case where the spacer body 15 is moved in the −Y direction to reach the opening of an adjacent pixel (not illustrated), the spacer body 15 does not contact and damage the alignment film disposed in the adjacent pixel as in the above-mentioned case.

In summary, the liquid crystal display in Embodiment 1 includes the electrode substrate 13 (array substrate), the opposing substrate 12, and the spacer 14. The electrode substrate 13 and the opposing substrate 12 are disposed to oppose each other to sandwich the liquid crystal. The spacer 14 is disposed between the surface 13A (the first main surface) of the electrode substrate 13 and the surface 12A (the second main surface) of the opposing substrate 12. The spacer 14 maintains the predetermined cell gap 18 between the electrode substrate 13 and the opposing substrate 12. The electrode substrate 13 includes the alignment film 24. The alignment film 24 is disposed over the surface 13A to align the liquid crystal in the predetermined alignment processing direction. The spacer 14 includes the base 16 and the spacer body 15. The base 16 is disposed over the surface 13A of the electrode substrate 13. The spacer body 15 is disposed over the surface 12A of the opposing substrate 12. The top portion of the spacer body 15 is in contact with the base 16. The height of the spacer body 15 is compressed by being subjected to stress in the direction to move the electrode substrate 13 and the opposing substrate 12 towards each other. The base 16 has the height greater than the amount of compression 15A of the spacer body 15.

In Embodiment 1, the electrode substrate 13 includes the plurality of gate wires (a plurality of first wires) and the plurality of source wires (a plurality of second wires). The plurality of gate wires extend in the X direction (the first direction) over the surface 13A, and are arranged at predetermined intervals. The plurality of source wires extend in the Y direction (the second direction) over the surface 13A, and are arranged at predetermined intervals. The plurality of gate wires and the plurality of source wires form the plurality of pixels arranged in a matrix to correspond to the intersections of the plurality of gate wires and the plurality of source wires. The spacer 14 is disposed outside the opening 19 as the light transmissive region in the at least one pixel 20 of the plurality of pixels. The alignment film 24 is disposed in the opening 19.

Such a liquid crystal display prevents damage of the alignment film 24 caused by displacement of the spacer 14 occurring due to bending of the electrode substrate 13 and the opposing substrate 12. Abnormal alignment and deterioration of display characteristics, such as escape of light, thus do not occur.

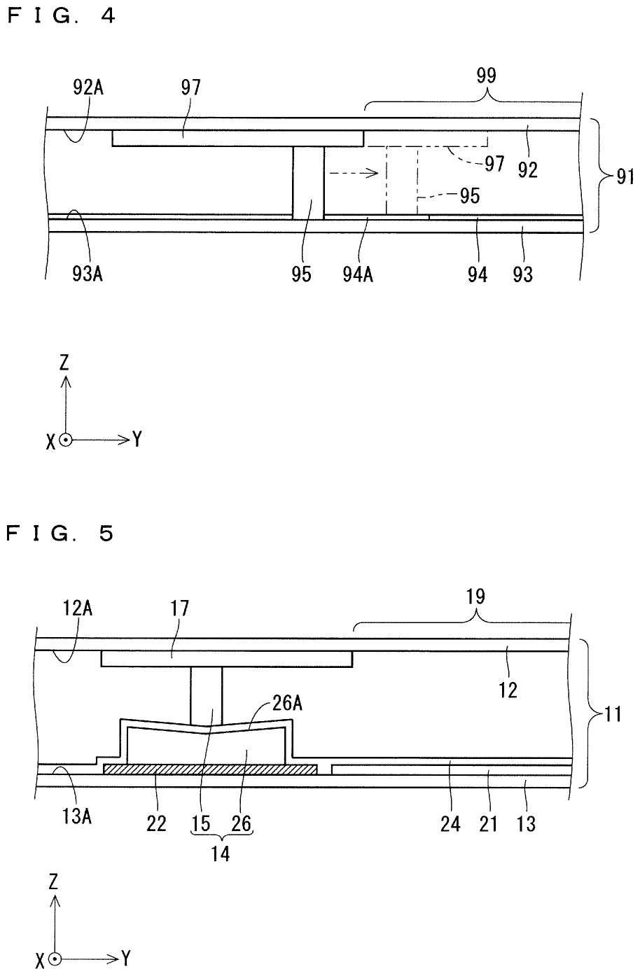

One example of a liquid crystal display not including the spacer 14 in Embodiment 1 is described herein. FIG. 4 is a sectional view illustrating a configuration of a liquid crystal display panel 91 not including the spacer 14 described in Embodiment 1. A unitary columnar spacer 95 is disposed between a surface 93A of an electrode substrate 93 and a surface 92A of an opposing substrate 92. In a case where the liquid crystal display panel 91 as described above is bent in a manufacturing process, the columnar spacer 95 is moved into an opening 99 inside a black matrix 97. In this case, the columnar spacer 95 damages the alignment film 94 while dragging on the alignment film 94. As a result, abnormal alignment occurs, and escape of light occurs to correspond to a trace of dragging 94A.

Even in a liquid crystal display including the spacer body 15 and the base 16, in a case where the base 16 has a height smaller than the amount of compression 15A of the spacer body 15, the spacer body 15 removed from the base 16 to increase in length contacts the alignment film 24 in the opening 19 to damage the alignment film 24.

On the other hand, the spacer body 15 in Embodiment 1 does not rub and damage the surface of the alignment film 24 even if the liquid crystal display panel 11 is bent in the manufacturing process. This prevents the occurrence of abnormal alignment to improve yield or improve quality. The structure of the spacer 14 in Embodiment 1 produces a significant effect especially in the liquid crystal display panel 11 as the transverse electric field panel. An effect similar to the above-mentioned effect is produced by a structure in which the gate wire 22 and the source wire 23 are replaced with each other.

The spacer 14 in Embodiment 1 is disposed on the side of the gate wire 22 of the plurality of gate wires connected to the transistor disposed in the at least one pixel 20 having the opening 19. The predetermined alignment processing direction of the alignment film 24 in the opening 19 corresponds to the X direction (the first direction).

In a case where the liquid crystal display has a configuration in which the direction of extension of the gate wire 22 and the alignment processing direction match each other, which is a so-called transverse slit-type configuration, a direction from the spacer body 15 to the opening 19 of the pixel 20 is a direction to intersect with the alignment processing direction. The conventional columnar spacer 95 in FIG. 4 thus causes damage in the direction to intersect with the alignment processing direction, so that significant abnormal alignment occurs in the liquid crystal display panel 91. On the other hand, the spacer body 15 in Embodiment 1 does not damage the alignment film 24 as the top portion thereof does not contact the alignment film 24 even in a case where the direction of extension of the gate wire 22 and the alignment processing direction match each other. Abnormal alignment thus does not occur.

### Modification of Embodiment 1

The spacer 14 in a modification of Embodiment 1 has a so-called dual-type configuration (not illustrated). That is to say, from among spacers 14 disposed in the liquid crystal display panel 11, some spacers each have the above-mentioned configuration in Embodiment 1, and the other spacers each include a sub-spacer body (not illustrated) having a smaller height than the above-mentioned spacer body 15. The sub-spacer body is not in contact with the base 16. An effect similar to the effect produced in Embodiment 1 is produced in a case where the spacer 14 has the dual-type configuration having a wide operating temperature range.

### Embodiment 2

A liquid crystal display in Embodiment 2 is described. Embodiment 2 is a subordinate concept of Embodiment 1, and the liquid crystal display in Embodiment 2 has each configuration of the liquid crystal display in Embodiment 1. Description of a configuration and operation similar to those in Embodiment 1 is omitted.

FIG. 5 is a sectional view illustrating a configuration of the liquid crystal display panel 11 of the liquid crystal display in Embodiment 2, and illustrates a cross section of a portion of the pixel 20. The liquid crystal display in Embodiment 2 includes a base 26 having a configuration different from that in Embodiment 1.

The base 26 has a contact surface 26A in contact with the top portion of the spacer body 15. The contact surface 26A slopes such that a height of the base 26 from the surface 13A of the electrode substrate 13 increases with decreasing distance to the opening 19 of the pixel 20.

This allows the liquid crystal display in Embodiment 2 to produce an effect of making the spacer body 15 less likely to be moved to the opening 19 in addition to the effect produced in Embodiment 1.

### Embodiment 3

A liquid crystal display in Embodiment 3 is described. Embodiment 3 is a subordinate concept of Embodiment 1, and the liquid crystal display in Embodiment 3 has each configuration of the liquid crystal display in Embodiment 1. Description of the similar configuration and operation is omitted.

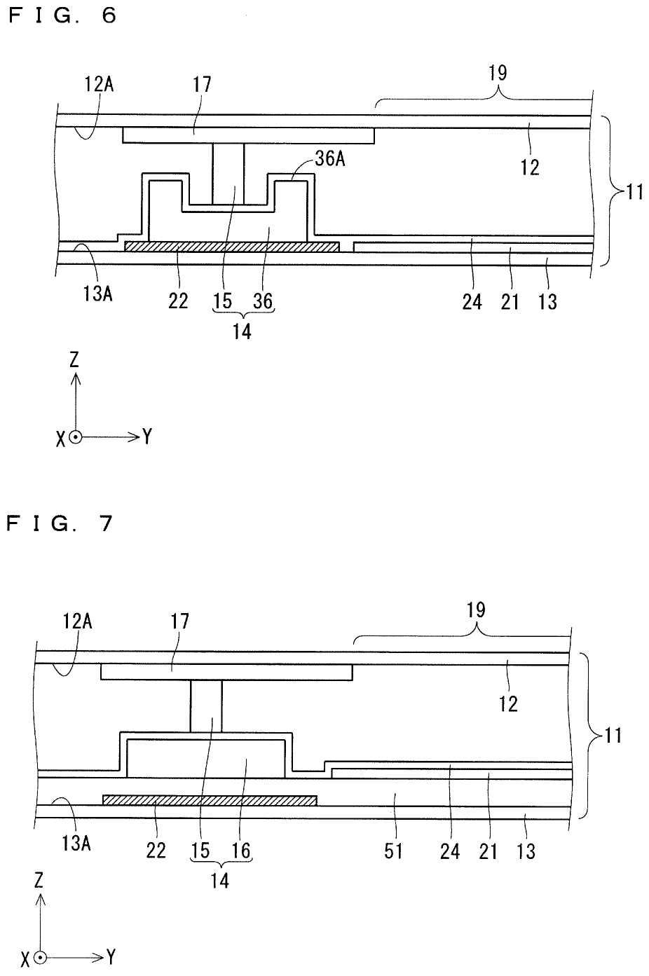

FIG. 6 is a sectional view illustrating a configuration of the liquid crystal display panel 11 of the liquid crystal display in Embodiment 3, and illustrates a cross section of a portion of the pixel 20. The liquid crystal display in Embodiment 3 includes a base 36 having a configuration different from that in Embodiment 1.

The base 36 has a contact surface 36A in contact with the top portion of the spacer body 15. The contact surface 36A is recessed such that a height of the base 36 from the surface 13A of the electrode substrate 13 increases with decreasing distance to the opening 19 of the pixel 20.

This limits a moving range of the spacer body 15, so that the liquid crystal display in Embodiment 3 produces the effect of making the spacer body 15 less likely to be moved to the opening 19 in addition to the effect produced in Embodiment 1.

### Embodiment 4

A liquid crystal display in Embodiment 4 is described. Embodiment 4 is a subordinate concept of Embodiment 1, and the liquid crystal display in Embodiment 4 has each configuration of the liquid crystal display in Embodiment 1. The liquid crystal display in Embodiment 4 may have a configuration similar to that in Embodiment 2 or 3. Description of the similar configuration and operation is omitted.

FIG. 7 is a sectional view illustrating a configuration of the liquid crystal display panel 11 of the liquid crystal display in Embodiment 4, and illustrates a cross section of a portion of the pixel 20.

A planarization film 51 to cover the gate wire 22 and the source wire 23 is disposed over the surface 13A of the electrode substrate 13. The base 16, the pixel electrode 21, and the alignment film 24 are disposed on the planarization film 51.

In a case where the spacer body 15 is removed from the base 16 and moved to the opening 19, the spacer body 15 and the alignment film 24 become close to each other as the planarization film 51 is formed. The base 16, however, has a height greater than the amount of compression 15A of the spacer body 15. The spacer body 15 does not rub and damage the surface of the alignment film 24. As described above, the liquid crystal display in Embodiment 4 prevents the spacer body 15 from rubbing and damaging the surface of the alignment film 24.

### Embodiment 5

A liquid crystal display in Embodiment 5 is described. Embodiment 5 is a subordinate concept of Embodiment 1, and the liquid crystal display in Embodiment 5 has each configuration of the liquid crystal display in Embodiment 1. The liquid crystal display in Embodiment 5 may have a configuration similar to that in any of Embodiments 2 to 4. Description of the similar configuration and operation is omitted.

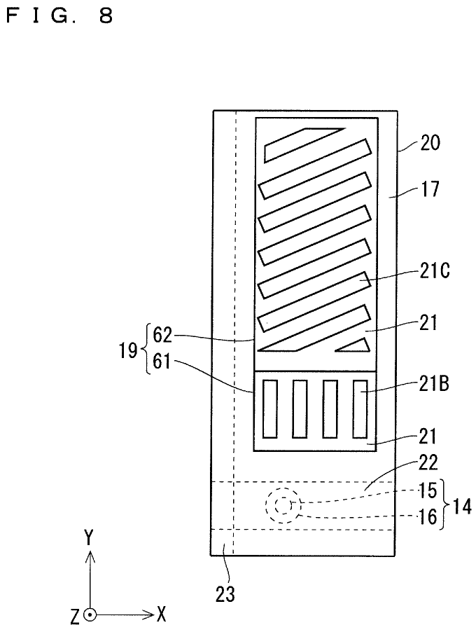

FIG. 8 is a plan view illustrating a configuration of the pixel 20 of the liquid crystal display in Embodiment 5. In Embodiment 5, the alignment processing direction of the alignment film 24 and a configuration of the pixel electrode 21 in the opening 19 are different from those in Embodiment 1.

The opening 19 has the first transmissive region 61 and the second transmissive region 62. That is to say, the liquid crystal display in Embodiment 5 has a structure in which alignment is divided in the opening 19, which is a so-called multi-domain structure. The first transmissive region 61 is disposed closer to the spacer 14 than the second transmissive region 62 is. The predetermined alignment processing direction of the alignment film 24 in the first transmissive region 61 corresponds to the Y direction, that is, a direction of extension of the source wire 23. The predetermined alignment processing direction of the alignment film 24 in the second transmissive region 62 corresponds to the X direction, that is, the direction of extension of the gate wire 22. As described above, the liquid crystal in the opening 19 in Embodiment 5 locally has longitudinal alignment. The alignment processing direction varying between the regions is formed through photo-alignment processing using a mask.

The pixel electrode 21 has slits 21B and slits 21C to control alignment of the liquid crystal respectively in the first transmissive region 61 and the second transmissive region 62. The slits 21B in the first transmissive region 61 are formed longitudinally, that is, parallel to the source wire 23. The slits 21C in the second transmissive region 62 are formed not parallel but obliquely to each of the gate wire 22 and the source wire 23.

As in Embodiment 1, even if the liquid crystal display panel 11 is bent in the Y direction to move the spacer body 15 into the opening 19 of the pixel 20, the spacer body 15 does not contact and damage the alignment film 24. In a case where the liquid crystal display panel 11 is greatly bent beyond a degree of curving assumed in advance, however, the spacer body 15 can become closer to the opening 19 and the alignment film 24, and a top portion of the spacer body 15 can rub and damage the surface of the alignment film 24. Even in such a case, the alignment processing direction in the first transmissive region 61 and a direction of damage caused by movement of the spacer body 15 are each the Y direction, and match each other. Local abnormal alignment is thus less likely to occur.

As described above, the liquid crystal display in Embodiment 5 prevents the occurrence of abnormal alignment. As a result, yield is improved or quality is improved.

### Embodiment 6

A liquid crystal display in Embodiment 6 is described. Embodiment 6 is a subordinate concept of Embodiment 1, and the liquid crystal display in Embodiment 6 has each configuration of the liquid crystal display in Embodiment 1. The liquid crystal display in Embodiment 6 may have a configuration similar to that in any of Embodiments 2 to 5. Description of the similar configuration and operation is omitted.

In Embodiment 6, the electrode substrate 13 and the opposing substrate 12 each have a horizontal shape, that is, are elongated in the direction of extension of the gate wire 22. The electrode substrate 13 or the opposing substrate 12 of the liquid crystal display panel 11 has also been slimmed to have a thickness of less than 0.3 mm.

Such a liquid crystal display is likely to be bent during handling, conveyance, and the like. The liquid crystal display in Embodiment 6, however, prevents the spacer body 15 from rubbing and damaging the surface of the alignment film 24 as in Embodiment 1.

### Embodiment 7

A liquid crystal display in Embodiment 7 is described. Embodiment 7 is a subordinate concept of Embodiment 1, and the liquid crystal display in Embodiment 7 has each configuration of the liquid crystal display in Embodiment 1. The liquid crystal display in Embodiment 7 may have a configuration similar to that in any of Embodiments 2 to 6. Description of the similar configuration and operation is omitted.

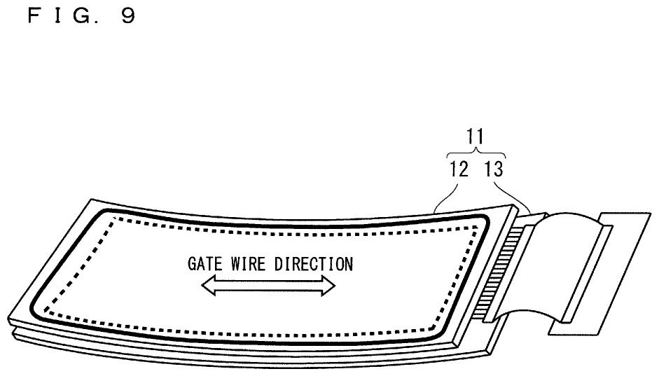

FIG. 9 is a perspective view illustrating a configuration of the liquid crystal display in Embodiment 7. In the liquid crystal display in Embodiment 7, the electrode substrate 13 or the opposing substrate 12 has been slimmed to have a thickness of less than 0.3 mm, and is elongated in the direction of extension of the gate wire 22, as in Embodiment 6. Furthermore, the electrode substrate 13 and the opposing substrate 12 are curved in the direction of extension of the gate wire 22. That is to say, the liquid crystal display in Embodiment 7 is a curved liquid crystal display.

As described in Embodiment 1, the spacer 14 is disposed outside the opening 19 and on the side of the gate wire 22 connected to the transistor disposed in the pixel 20 having the opening 19. Thus, in a case where the curved liquid crystal display is elongated in the direction of extension of the gate wire 22, displacement to move the spacer body 15 into the opening 19 is less likely to occur. In a case where the electrode substrate 13 or the opposing substrate 12 has significantly been slimmed to have a thickness of less than 0.3 mm, however, a degree of bending is large. Large displacement in a longitudinal direction of the liquid crystal display panel 11, that is, the direction from the spacer body 15 to the opening 19 is thus likely to occur. Even in such a case, the liquid crystal display in Embodiment 7 prevents the spacer body 15 from contacting the alignment film 24 in the opening 19 to damage the alignment film 24. It prevents the occurrence of abnormal alignment to improve yield or improve quality. As a result, an optimum structure can be obtained.

Embodiments of the present invention can freely be combined with each other, and can be modified or omitted as appropriate within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display comprising:
an array substrate and an opposing substrate disposed to oppose each other to sandwich a liquid crystal; and
a spacer disposed between a first main surface of the array substrate and a second main surface of the opposing substrate to maintain a predetermined cell gap between the array substrate and the opposing substrate, wherein
the array substrate includes
an alignment film disposed over the first main surface to align the liquid crystal in a predetermined alignment processing direction,
the spacer includes:
a base disposed over the first main surface of the array substrate; and
a spacer body disposed over the second main surface of the opposing substrate, a top portion of the spacer body being in contact with the base, a height of the spacer body being compressed by being subjected to stress in a direction to move the array substrate and the opposing substrate towards each other, and
the base has a height greater than an amount of compression of the height of the spacer body.

2. The liquid crystal display according to claim 1, wherein
the array substrate includes:
a plurality of first wires extending in a first direction over the first main surface, and arranged at predetermined intervals; and
a plurality of second wires extending in a second direction over the first main surface, and arranged at predetermined intervals,
the plurality of first wires and the plurality of second wires form a plurality of pixels arranged in a matrix to correspond to intersections of the plurality of first wires and the plurality of second wires,
the spacer is disposed outside an opening as a light transmissive region in at least one of the plurality of pixels, and
the alignment film is disposed in the opening.

3. The liquid crystal display according to claim 2, wherein
the spacer is disposed on a side of one of the plurality of first wires connected to a transistor disposed in the at least one pixel having the opening, and
the predetermined alignment processing direction of the alignment film in the opening corresponds to the first direction.

4. The liquid crystal display according to claim 1, wherein
the spacer further includes a sub-spacer body having a smaller height than the spacer body, and not being in contact with the base.

5. The liquid crystal display according to claim 2, wherein
the base has a contact surface in contact with the top portion of the spacer body, and
the contact surface slopes such that a height of the base from the first main surface of the array substrate increases with decreasing distance to the opening.

6. The liquid crystal display according to claim 2, wherein
the base has a contact surface in contact with the top portion of the spacer body, and
the contact surface is recessed such that a height of the base from the first main surface of the array substrate increases with decreasing distance to the opening.

7. The liquid crystal display according to claim 2, wherein
the array substrate further includes a planarization film to cover the plurality of first wires and the plurality of second wires, and
the base and the alignment film are disposed on the planarization film.

8. The liquid crystal display according to claim 2, wherein
the spacer is disposed on a side of one of the plurality of first wires connected to a transistor disposed in the at least one pixel having the opening,
the opening has a first transmissive region and a second transmissive region,
the first transmissive region is disposed closer to the spacer than the second transmissive region is,
the predetermined alignment processing direction of the alignment film in the first transmissive region corresponds to the second direction, and
the predetermined alignment processing direction of the alignment film in the second transmissive region corresponds to the first direction.

9. The liquid crystal display according to claim 2, wherein
the array substrate and the opposing substrate are elongated in the first direction.

10. The liquid crystal display according to claim 9, wherein
the array substrate and the opposing substrate are curved in the first direction.
